(19) United States
(12) Patent Application Publication
(10) Pub. No.: US 2026/0357439 A1
(43) Pub. Date: Nov. 12, 2026

(54) SUBSTRATE FOR CERAMIC THIN FILM AND THIN FILM DEVICE

(71) Applicant: TDK Electronics AG, Munchen (DE)

(72) Inventors: Federica Benes, Graz (AT); Marius Steffens, Bad Gams (AT); Manfred Schweinzger, Bad Schwanberg (AT)

(21) Appl. No.: 19/133,359

(22) PCT Filed: Nov. 24, 2023
(86) PCT No.: PCT/EP2023/082946

§ 371 Date: May 28, 2025

(30) Foreign Application Priority Data
Dec. 9, 2022 (DE) 102022132815.5

(51) Int. Cl. C23C 30/00; H01G 4/30

(52) U.S. Cl. CPC C23C 30/005; H01G 4/306

(57) ABSTRACT

The present invention concerns a substrate (2) for the deposition of a thin film (5) comprising a base layer (3) comprising titanium and an intermediate (4) layer comprising titanium oxide. The substrate (2) is adapted that a thin film ceramic layer (5) can be deposited on the intermediate layer. Further, the invention concerns a thin film device (2) comprising the substrate (2) and a ceramic thin film layer (5) and a manufacturing method.

### CROSS-REFERENCE TO RELATED APPLICATIONS

This patent application is a national phase filing under section 371 of PCT/EP2023/082946, filed Nov. 24, 2023, which claims the priority of German patent application no. 102022132815.5, filed Dec. 9, 2022, each of which is incorporated herein by reference in its entirety.

### TECHNICAL FIELD

The disclosure concerns a substrate for the deposition of a ceramic thin film and a thin film device comprising the substrate and the ceramic thin film and manufacturing methods for the substrate and the thin film device.

### BACKGROUND

Ceramic thin film elements comprising of a metallic substrate and a dielectric ceramic thin film layer are typically fabricated via chemical solution deposition.

The substitution of the ceramic material with foreign atoms is commonly used to tune the ceramic material properties, such as the dielectric constant or the piezoelectric coefficient to adapt the ceramic material depending on the application.

The ceramic thin films can be fabricated on a metal substrate but the usual processing comprises many application steps to achieve the final film thickness. This processing favors atomic and ionic interdiffusion between the substrate and the thin film and increases the residual stress.

Moreover, the presence of numerous coating steps raises the cost and the overall processing time, also damaging the final stack.

In general, the chosen metallic substrate for such devices is stainless steel due to the low cost and high availability. A State of the art example is disclosed in WO 2021/249844 A1. Other metals suitable for the metallic substrates are described for example in US 2004/0175585 A1 and in non-patent document J. F. Ihlefeld et al.: Journal of Materials Research, Volume 20, Issue 10, October 2005, pp. 2838-2844. Suitable ceramic material compositions are described for example in WO 2021/064036 A1 and WO 2019/174719 A1. In WO 2022/122445 A2 ceramic thick films comprising such suitable ceramic material compositions deposited on ceramic substrates are described.

Mostly, to avoid interdiffusion between the stainless steel substrate and the ceramic thin film, an intermediate layer such as lanthanum nickelate (LNO) is deposited.

However, the LNO layer does not contribute to the reduction of the defects arising when crystalizing the thin film on the stainless steel at high temperatures, such as atomic and ionic interdiffusion and formation of an unwanted mixed oxide layer on the substrate surface.

### SUMMARY

Embodiments provide an improved substrate, thin film device and manufacturing method.

Embodiments provide a substrate.

The substrate comprises a base layer and an intermediate layer. The substrate is adapted that a thin film ceramic layer can be deposited on the intermediate layer.

The base layer is a metallic layer comprising titanium. According to an embodiment titanium is the main component of the base layer. The base layer may consist of a composition with 100 atom % titanium (Ti). According to an embodiment, the base layer consists of titanium.

Other possible, but non-inventive, materials for the metallic layer may comprise or consist of copper, nickel or steel.

The base layer comprising titanium has several advantages.

Since titanium is electrically conductive, the base layer may serve as a base electrode by which the thin film may be electrically contacted.

Further, the base layer shows flexible or elastic mechanical behavior.

Additionally, titanium may be handled and processed in an air atmosphere. Exclusion of air oxygen is not required.

The intermediate layer comprises titanium oxide. The titanium oxide is preferably thermally grown titanium oxide. Alternatively, the titanium oxide is anodically grown titanium oxide.

Other possible, but non-inventive, materials for the intermediate layer may comprise or consist of copper oxide, nickel oxide or oxidized steel surfaces.

According to an embodiment, titanium oxide (TiO₂) is the main component of the intermediate layer. The intermediate layer may consist of a composition with 100 atom % titanium oxide. Preferably, the intermediate layer consists of titanium oxide.

The described intermediate layer exhibits high homogeneity, in particular a homogenous structure and composition, and thus homogeneous electrical and mechanical properties. The electrical and mechanical properties can precisely be set.

An oxidation layer formed by natural oxidation would comprise different foreign atoms and does not consist of pure titanium oxide.

In an embodiment, the substrate is configured for the deposition of a ceramic thin film.

In particular, the intermediate layer may be adapted that a thin film ceramic layer can be deposited on the intermediate layer.

The intermediate layer has an appropriate structure, density and thickness to prevent interdiffusion between the base layer and the thin film.

Further, the intermediate layer allows a stable and permanent deposition of the thin film on the substrate.

The intermediate layer has preferably a suitable structure and minimum layer thickness to exhibit self-healing oxidation properties.

In particular, the intermediate layer can be self-healed by applying an electrical field to the substrate inducing formation of new titanium oxide.

In an embodiment, the intermediate layer and the base layer are direct adjacent layers. No layer is deposited between these two layers. Further, no other structures are arranged between the intermediate layer and the base layer.

The intermediate layer prevents the formation of a mixed oxide layer between the base layer and the thin film ceramic layer.

In an embodiment, the substrate consists of the base layer and the intermediate layer.

No further functional layers are required. The base layer may serve as a base electrode.

In other embodiments, the substrate may comprise a separate electrode layer or additional structural or protection layers.

The electrode layer or several electrode layers may consist of a conductive metal such as gold, chrome, silver, platinum, copper, titanium or a combination of them or a metal oxide with a thickness up to 1 μm.

Examples for the metal oxides are lanthanum nickel oxide (LNO), indium tin oxide (ITO), aluminum zinc oxide (AZO).

Further, the electrode may comprise a stack of several stacked metal layers, e.g. a Cr/Ni/Ag stack or a Cr/Ni/Au stack.

The electrode layer may be deposited by chemical solution deposition, sputtering, lithography, screen printing, inkjet-printing or another suitable technique.

In an embodiment, the base layer has a thickness between 5 μm and 1000 μm. Preferably, the base layer has a thickness between 5 μm and 200 μm, more preferably between 5 μm and 100 μm. Thus, the base layer is highly flexible. The material consumption for producing the substrate can be reduced.

In an embodiment, the base layer has a surface roughness Ra of less than 0.5 μm, preferably less than 0.3 μm. Thus, the surface of the base layer is suitable for forming a smooth intermediate layer on it. Thus, geometrical and structural properties of the intermediate layer can be exactly adapted.

In an embodiment, the intermediate layer has a thickness between 0.1 μm and 2 μm, preferably between 0.8 μm and 1 μm.

The thickness of the intermediate layer is preferably significantly higher than the thickness of a natural oxidation layer on the titanium base layer. The intermediate layer with the described thickness exhibits desired mechanical and electrical properties. In particular, the intermediate layer exhibits self-healing properties.

Because of the chosen thickness, the intermediate layer is highly flexible. The material consumption for producing the substrate can be reduced. On the other hand, the intermediate layer has a sufficient thickness to prevent interdiffusion between the base layer and the thin film ceramic layer.

Further, embodiments concern a thin film device comprising the substrate as described before and the thin film ceramic layer.

By combining the described substrate with a base layer comprising titanium and an intermediate layer comprising titanium oxide and the ceramic thin film, interdiffusion, in particular atomic and ionic interdiffusion, between the base layer and the thin film may be suppressed during a manufacturing process or a deposition process of the thin film ceramic layer on the substrate. Thus, the substrate and the thin film comprise homogeneous material phases with only a few or preferably no impurities. Thus, the mechanical and electrical properties of the substrate can be exactly adjusted.

The thin film ceramic layer is applied or deposited on the intermediate layer.

In an embodiment, the intermediate layer and the thin film ceramic layer are direct adjacent layers. The intermediate layer is suitable to accommodate the thin film ceramic layer.

In other embodiments, further functional or structural layers may be arranged between the intermediate layer and the thin film ceramic layer, e.g. an inner electrode layer.

In an embodiment, the thin film device consists of the substrate and the thin film ceramic layer. No further layers are required.

In an embodiment, the thin film ceramic layer may comprise a poly-crystalline, an oligo-crystalline or a mono-crystalline structure.

In this embodiment, the device may be used as a dielectric electrode structure to apply an electric field to a selected object. A dielectric electrode can be understood as a setup provides an electrically conductive feature and an insulating feature. For example the dielectric electrode can have at least one conductive layer and one insulating layer. In particular it is preferred that a dielectric electrode comprises a substrate providing conductivity and on top of the substrate a material of high dielectric constant, such as the ceramic materials described below.

In an embodiment, the thin film device comprises an inner electrode layer for electrical connection.

In an embodiment, the thin film device comprises several inner electrode layers. In this embodiment, the device may be used as multilayer electrode capacitor or multilayer ceramic capacitor. An electrical field may be applied to the thin film layer between two or several inner electrode layers.

In an embodiment, the device may comprise several, e.g. two or multiple, thin film ceramic layers. The thin film ceramic layers may be arranged between the single electrode layers. The ceramic thin film layers and electrode layers may form a stack.

The thin film device may be completed by a top electrode. No further ceramic thin film layer is stacked on the top electrode. The top electrode completes the thin film device at a side of the thin film device opposite to side completed by the substrate.

The top electrode may or may not cover the whole area of the ceramic thin film layer and can exhibit different shapes.

The electrical field may be applied in a stacking direction of the layers. Thus, the stack may form a multilayer electrode capacitor structure in which several capacitor elements are connected in series.

The electrical field may also be applied in a direction vertical to the stacking direction. The inner electrodes may contact outer electrodes on two sides of the stack vertical to the stacking direction. In this way, a multilayer ceramic capacitor (MLCC) may be formed.

In an embodiment, the thin film ceramic layer comprises a ceramic material which is a perovskite ceramic with a general structure ABO₃.

In an embodiment, the thin film ceramic layer comprises a ceramic material with a ceramic composition Ba(ZrₓTi₁₋ₓ)O₃, wherein preferably 0.05≤x≤0.6 is fulfilled.

In an embodiment, the thin film ceramic layer may consist of the ceramic material.

Further, the ceramic material may comprise dopants to modify the properties of the ceramic.

In an embodiment, the ceramic material comprises y weight % of a rare earth metal dopant, in particular yttrium, wherein preferably 0.2≤y≤2 is fulfilled. The ratio y refers to 100 weight % of Ba(ZrₓTi₁₋ₓ)O₃.

In an embodiment, the ceramic material comprises z weight % of a transition metal dopant, in particular manganese, wherein preferably 0.11≤z≤1 is fulfilled. The ratio z refers to 100 weight % of Ba(ZrₓTi₁₋ₓ)O₃.

The ceramic material has favorable electrical and mechanical properties, in particular when used in a thin film. Further, the material is environmentally compatible since free of lead.

In alternative embodiments, a ceramic material comprising lead such as (PbₓZr₁₋ₓ)TiO₃ with preferable x values between 0.4 and 0.6 (0.4≤x≤0.6) or Pb(MnₓNb₁₋ₓ)O₃+PbTiO₃ with preferable x values between 0.2 and 0.4 (0.2≤x≤0.4) are chosen which have also favorable electrical and mechanical properties when used in a thin film.

In an embodiment, the thin film device is configured as a circular plate.

A circular shape has advantages in manufacturing, handling and application, e.g. with respect to mechanical stability.

In an embodiment, the thin film device is configured as a three-dimensionally folded foil.

The folded foil may be adapted to the shape of different application objects in a flexible way. In particular, the foil may be elastic and may be suitable to be folded into various shapes and to be re-folded into its original shape afterwards.

In particular, the foil may comprise several cuts or cut-outs according to Japanese Kirigami technique in order to achieve the desired flexible properties for folding.

In an embodiment, the ceramic thin film has a thickness between 0.3 μm and 5 μm, preferably between 0.3 μm and 1.5 μm.

Since these dimensions are sufficient to achieve the desired mechanical properties, the consumption of ceramic material may be reduced. The thin film layer has preferably homogeneous mechanical and electrical properties.

According to embodiments, the thin film device as described before may be used as a dielectric electrode structure or as a capacitor structure or as a multilayer capacitor structure as described in detail before.

Further, embodiments concern a dielectric electrode structure, a capacitor structure, a multilayer capacitor structure, in particular a multilayer electrode capacitor structure or a multilayer ceramic capacitor (MLCC) structure, comprising the thin film device as described in detail before.

Further, embodiments concern a medical device for medical, diagnostic or therapeutic treatment, e.g. electrical cancer treatment, comprising the thin film device or particularly the dielectric electrode structure.

Further, embodiments concern a method for manufacturing a substrate for the deposition of a thin film comprising several steps.

The substrate and the ceramic thin film may be configured as described before. In particular, the before described substrate and ceramic thin film may be manufactured by the following method.

In a first step a titanium foil is provided to form a base layer.

In another step the base layer is thermally or anodic treated to form an intermediate layer directly adjacent to the base layer. The intermediate layer comprises titanium oxide or consists of titanium oxide.

By forming the titanium oxide layer directly on the base layer the formation of a natural mixed metal oxidation layer is prevented.

In an embodiment, the base layer is heated up to a first holding temperature, preferably between 550 °C and 620 °C, in a first step and to a second holding temperature, preferably between 640 °C and 700 °C, in a second step during thermally treatment.

By the described stepwise thermal processing a dense intermediate layer with no open porosity can be manufactured. This may be understood such that an accordingly produced film can be dense. Also, it can be free from open pores.

Due to the described thermal treatment the intermediate layer with the desired properties is formed.

Further, embodiments concern a method for manufacturing a thin film device comprising the substrate for the deposition of a thin film. The method may comprise the before mentioned steps. Further, the method may comprise several additional steps.

In a step, a ceramic material for a ceramic thin film layer in a viscous state is provided. The ceramic material in the viscous state may be a viscous paste comprising organic substances and/or solvents.

In another step, the ceramic material is disposed in the viscous state on a surface of the intermediate layer facing away from the base layer to form a thin film ceramic layer.

After deposition, the deposited thin film ceramic layer is dried, preferably on a hotplate. Preferably, drying of the ceramic thin film is conducted at a temperature between 150 °C and 250 °C. In this step remaining solvents may be removed.

After drying, the dried thin film ceramic layer is calcinated or pyrolyzed. Preferably, calcination of the thin film is conducted in two steps at temperatures between 300 °C and 600 °C, preferably in a furnace. A first calcination step may be conducted between 300 °C and 400 °C. A second calcination step may be conducted between 500 °C and 600 °C. In this step remaining organic substances may be removed.

In another step, the calcined thin film ceramic layer is crystallized, preferably in a furnace. Crystallizing of the thin film is preferably conducted at a temperature between 600 °C and 700 °C.

In an embodiment, the deposition of the ceramic material is done by slot die coating.

By slot die coating the ceramic thin film layer can be deposited in a desired thickness and structure.

Alternative methods for depositing the thin film layer would be spin coating or dip coating, spray pyrolysis and inkjet printing. Alternatively, the thin film layer may also be deposited by physical methods such as sputtering, physical vapor deposition (PLD) or aerosol deposition. In this case a solid ceramic target and/or ceramic powder with the desired composition is used.

In an embodiment, the ceramic material is deposited by stacking several sublayers, wherein each sublayer has a thickness between 0.1 μm and 0.5 μm. Preferably, each sublayer has a thickness between 0.2 μm and 0.3 μm. The required thickness of the sublayers is achieved by the selection of a suitable viscous ceramic material, e.g. a suitable ceramic paste with a suitable composition. Preferably, the ceramic paste comprises an organic polymer material.

By the application of the sublayers with the described thickness, the whole ceramic thin film layer can be formed by the application of only a few sublayers, preferably one to five sublayers.

The whole process of deposition, drying, calcination/pyrolysis and crystallization may be carried out one to five times until the final thickness of the ceramic thin film layers is reached.

By reducing the number of sublayers, a homogeneous structure of the ceramic thin film layer can be obtained. The susceptibility to defects or damages during manufacturing is reduced.

In an embodiment, providing the ceramic material in the viscous state comprises several steps. Preferably the steps comprise a chemical solution deposition procedure.

In a step, a first solution is prepared by dissolving a barium salt, e.g. barium acetate. The barium salt may be dissolved in glacial acetic acid, water and ethanolamine.

Optionally, an yttrium salt, e.g. yttrium acetate, and a manganese salt, e.g. manganese acetate, may be dissolved in the first solution to get a doped ceramic material.

In another step, a second solution is prepared by dissolving an organic polymer in an appropriate solvent, e.g. in ethanol and acetic acid. The organic polymer may be polyvinylpyrrolidone (PVP).

In another step, titanium tetraethoxide and zirconium propoxide are dissolved in the second solution. Simultaneously, the solution may be stirred.

Then, the first and the second solution are mixed, and preferably stirred, to form a sol gel.

In a preferred embodiment, the first solution is prepared by dissolving a stoichiometric amount of barium acetate, and optionally yttrium acetate and manganese acetate, in 5 to 15 moles of glacial acetic acid and 2 to 8 moles of water and ethanolamine. Further, 0.1 to 0.8 moles of polyvinylpyrrolidone are dissolved in 3 to 10 moles of ethanol and 15 to 30 moles of acetic acid to prepare the second solution. Titanium tetraethoxide and zirconium propoxide are added stoichiometrically to the second solution while stirring. Then, the first solution is added to the second solution. Both solutions are mixed together by stirring.

Preferably, the resulting solution forms a ceramic paste with a viscosity between 10 and 100 cP (1 cP=10⁻³ kg/ms).

In an embodiment, a geometrical shape of the thin film device is configured by cutting, e.g. by mechanical cutting or laser cutting, or by punching.

In an embodiment, the thin film device is three-dimensionally shaped by cutting or punching and folding the thin film device. In particular, the thin film device may be three-dimensionally shaped by using Kirigami technique, which is a combination of cutting and Origami folding technique. Cut-out or punched-out sections may make the thin film device more flexible. The thin film device may be adapted to the outer shape of various objects to which the device is applied.

The application of Kirigami technique applied allows flat device structures to become three-dimensional structures when a force is applied and to come back to the original flat structure when the force is removed without leaving the device deformed.

Kirigami cut devices are superior to other ceramic thin film devices due to the capacity to adapt to moving or expanding elements and to optimize the contact to these elements, especially in case of larger contact areas. Exemplarily elements are moving machine elements or a human or animal body.

Different designed motives may be cut or punched into the devices.

### BRIEF DESCRIPTION OF THE DRAWINGS

In the following, the invention will be explained in more detail with reference to accompanied drawings. The drawings show:

FIG. 1 shows a first embodiment of a thin film device in a cross-sectional view;

FIG. 2 shows a SEM (scanning electron microscopy) picture of a cross-section of the first embodiment of the thin film device;

FIG. 3 shows a second embodiment of a thin film device in a cross-sectional view;

FIG. 4 shows a third embodiment of a thin film device in a cross-sectional view;

FIG. 5 shows a forth embodiment of a thin film device in a cross-sectional view;

FIG. 6 shows a process scheme of significant manufacturing steps;

FIG. 7 shows a possible circular shape of the finished thin film device;

FIG. 8 shows a possible three-dimensional folded shape of the finished thin film device;

FIG. 9 shows two SEM pictures. On the right the cross-section of the first embodiment of the thin film device is shown. On the left a cross-section through a differently manufactured thin film device is shown for comparison;

FIG. 10 shows the dependency of electrical power losses on the electrical frequency for the two different thin film devices shown in FIG. 9;

FIG. 11 shows the dependency of capacitance density and electrical power losses on the electrical frequency for the first embodiment of the thin film device;

FIG. 12 shows the dependency of capacitance and electrical power losses on the temperature for the first embodiment of the thin film device. A temperature range around body temperature (37 °C) is chosen;

FIG. 13 shows the dependency of capacitance and electrical power losses on the temperature for differently manufactured ceramic devices shown for comparison in FIG. 9, left side. Again, a temperature range around body temperature (37 °C) is chosen; and

FIG. 14 shows the dielectric breakdown strength of the first embodiment of the thin film device. The dependency of electric current on the electric filed is measured. The breakdown point is about 33 kV/mm.

Similar or apparently identical elements in the figures are marked with the same reference signs. The figures and the proportions in the figures are not scalable.

### DETAILED DESCRIPTION OF ILLUSTRATIVE EMBODIMENTS

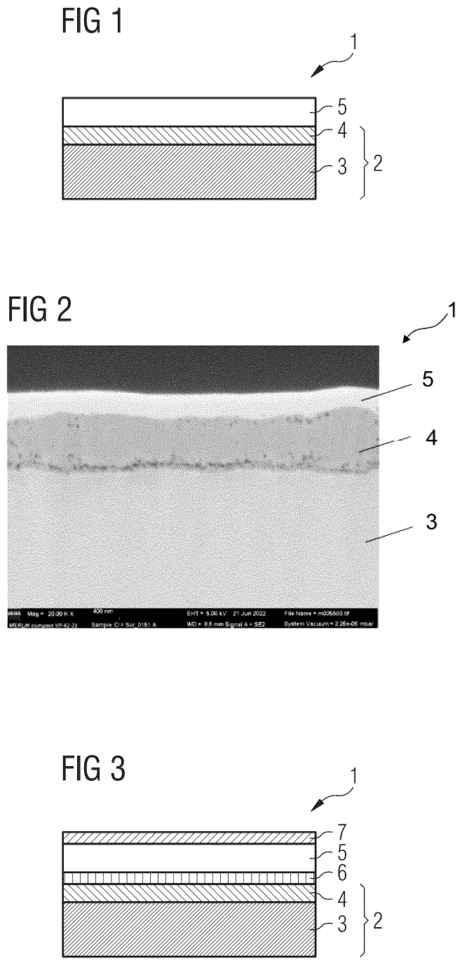

FIG. 1 shows an embodiment of the thin film device 1. The thin film device 1 comprises a substrate 2 comprising the base layer 3 and an intermediate layer 4 and further comprising a ceramic thin film layer 5.

The mentioned layers are stacked in a stack forming a multilayer device 1.

The base layer 3 comprises titanium metal. Preferably, the layer 3 consists of titanium (Ti).

The base layer 3 may consist of a Ti foil. The thickness of the Ti foil may be between 5 μm and 1000 μm, preferably 5 μm and 100 μm.

Directly on a surface of the base layer 3 the intermediate layer 4 is arranged. No further layer or structure is arranged between the base layer 3 and the intermediate layer 4.

The intermediate layer 4 comprises titanium oxide TiO₂ or consists preferably of titanium oxide. The titanium oxide has preferably a rutile structure.

The thickness of the intermediate layer may be between 0.1 μm and 2 μm, preferably 0.8 μm and 1 μm.

The substrate 2 may function as an electrode to contact the ceramic thin film. Alternatively, in another embodiment, a separate electrode layer may be provided configured as bottom electrode between the substrate 2 and the ceramic thin film layer 5 or as a top electrode whereby the ceramic thin film layer 5 is sandwiched between the substrate and the top electrode.

On the surface of the intermediate layer 4 opposite to the surface contacting the base layer 3, the ceramic thin film layer 5 is deposited.

The ceramic thin film may have a thickness between 0.3 μm and 5 μm, preferably between 1.5 μm and 5 μm.

In the shown embodiment, the ceramic thin film layer 5 is directly adjacent to the intermediate layer 4. No further layers or structures are arranged in between.

The ceramic thin film layer 5 may comprise or consist of a ceramic material with the composition Ba(ZrₓTi₁₋ₓ)O₃, wherein preferably 0.05≤x≤0.6 is fulfilled.

In table 1 the results of an EDX (energy-dispersive X-ray spectroscopy) measurement of the composition of the base layer, the intermediate layer and the ceramic thin film of an exemplarily ceramic thin film device are shown. The ratios of the different elements are stated in atom %.

TABLE 1

| | O | Ti | Zr | Ba |
|---|---|---|---|---|
| Ceramic thin | 67 | 14 | 2 | 18 |
| film | | | | |
| Intermediate | 65 | 35 | — | — |
| layer | | | | |
| Base layer | — | 100 | — | — |

Further, the ceramic material preferably comprises dopants to modify the properties of the ceramic. In particular, the ceramic material comprises e.g. y weight % of a rare earth metal dopant, in particular yttrium, wherein 0.2≤y≤2 is fulfilled. The ratio y refers to 100 weight % of Ba(ZrₓTi₁₋ₓ)O₃. Further, the ceramic materials comprises e.g. z weight % of a transition metal dopant, in particular manganese, wherein 0.11≤z≤1 is fulfilled. The ratio z refers to 100 weight % of Ba(ZrₓTi₁₋ₓ)O₃.

FIG. 2 shows a SEM picture of a cross-section through the thin film device 1 according to the first embodiment. The base layer 3, intermediate layer 4 and ceramic thin film layer 5 are shown. The shown surface of base layer 3 has a favorable low surface roughness Ra of less than 0.3 μm.

FIG. 3 shows another embodiment of the device 1.

Different to the first embodiment, the second embodiment of the device 1 comprises some additional layers.

A metallic inner electrode layer 6 for electrical contacting is arranged between the intermediate layer 4 and the thin film layer 5.

On the opposite surface of the thin film layer 5 a second electrode 7 is deposited.

The second embodiment of the thin film device 1 may be used as an electric capacitor, whereas the first embodiment may be used as a dielectric electrode structure for the application of an electric field to a selected object, in particular to a human body, e.g. for medical, diagnostic or therapeutic applications.

Due to its electrical properties, the thin film device 1 may in general be suitable to be used at body temperature.

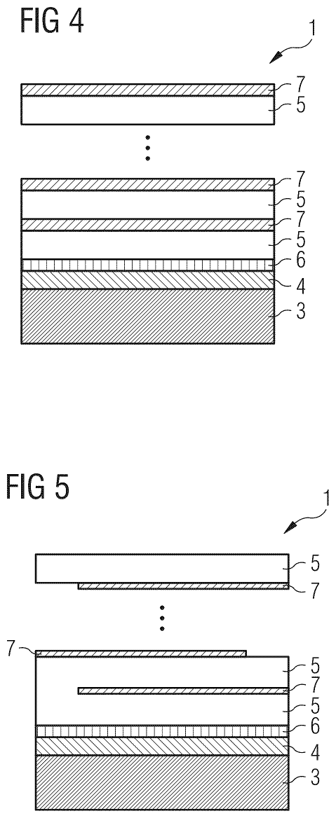

In FIG. 4 a device 1 configured as a multilayer electrode capacitor is shown. The capacitor device 1 is built by stacking several ceramic thin film layers 5 and electrode layers 7. Thus, a series of single capacitor elements is formed.

In FIG. 5, a device 1 configured as a multilayer ceramic capacitor (MLCC) is shown. The capacitor device 1 comprises several ceramic thin film layers 5 and electrode layers 7, wherein the electrode layers are alternately contacted by two different outer electrodes on opposite side surfaces of the device 1.

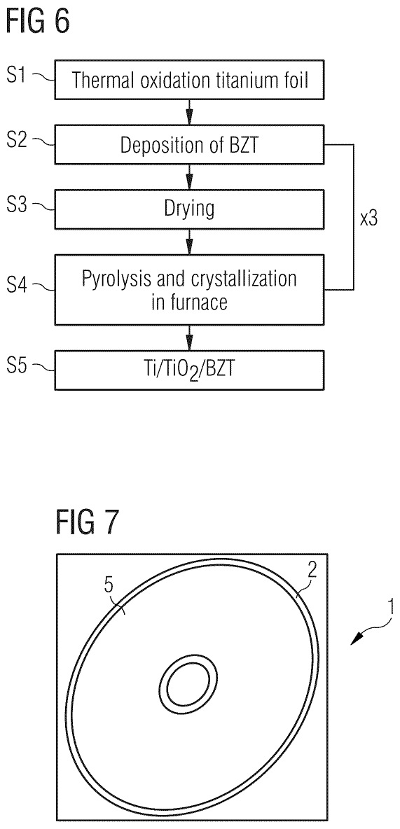

FIG. 6 graphically summarizes selected steps of the manufacturing process of the first embodiment of the thin film device 1.

A first solution is prepared by dissolving e.g. barium acetate, yttrium acetate and manganese acetate in glacial acetic acid, water and ethanolamine. In a second solution, polyvinylpyrrolidone is dissolved in ethanol and acetic acid. Titanium tetraethoxide and zirconium propoxide are added to the second solution while stirring. The first and the second solutions are mixed to form a sol gel.

Further, in graphically shown step S1 the titanium foil for the substrate 2 is provided and thermally treated in a furnace in an air atmosphere by heating it to a temperature between 550 °C and 620 °C in a first step and then between 640 °C and 700 °C in a second step. By the described thermal treatment process the intermediate layer 4 is formed on the surface of the titanium base layer 3.

In step S2, the pre-prepared sol gel is deposited e.g. either via spin coating, dip coating or slot die coating onto the substrate 2 with a thickness of up to 0.05 mm. In step S3, the thin film 5 is then dried e.g. on a hotplate at a temperature between 150 °C and 250 °C. Afterwards, in step S4, the ceramic thin film layer is pyrolyzed two times by heating the device 1 in an oven in air atmosphere at temperatures between 300 °C and 400 °C and 500 °C and 600 °C afterwards.

Furthermore, the ceramic thin film layer 5 is crystallized in a furnace between 600 °C and 700 °C in an air atmosphere.

The process of deposition, drying, calcination/pyrolysis and crystallization is carried out three to five times until the final thickness of the ceramic thin film layer 5 is reached in step S5.

Afterwards, a preferable geometrical shape may be punched or cut out of the provided layer structure in order to obtain a desired shape of the device 1.

FIG. 7 shows an exemplarily circular punched shape of a finished thin film device with a through-hole in its center.

The circular element may have a diameter between 10 mm and 25 mm with a concentric through-hole with a diameter between 3 mm and 4 mm.

Generally, the ceramic thin film layer 5 may cover a whole surface of the substrate 2 or only a defined area. For example, a section of the substrate close to the edge of the substrate may retain uncovered as shown e.g. in FIG. 7.

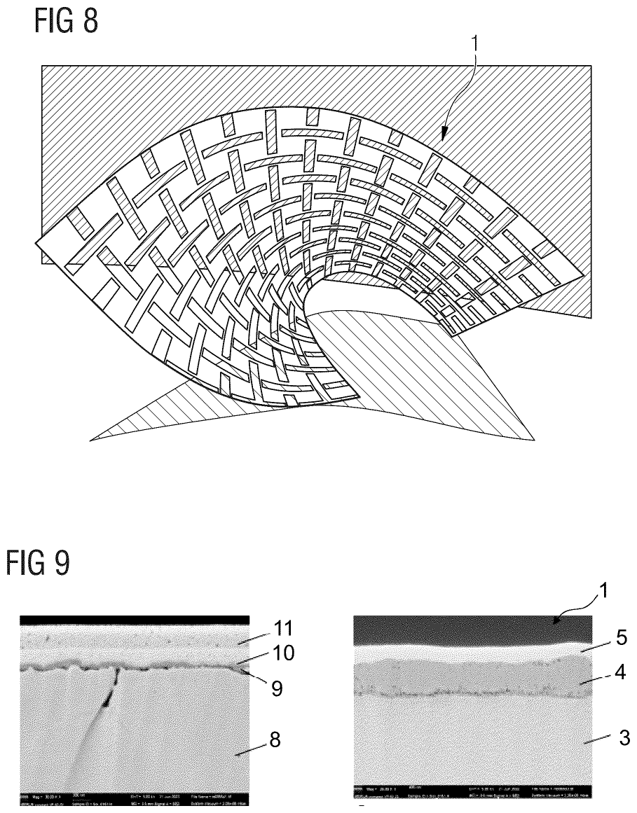

FIG. 8 shows another embodiment of the device 1, alternative to FIG. 7. The device 1 is manufactured by using Kirigami technique.

The embodiment in FIG. 8 is just an example of a Kirigami pattern. More different patterns may be created by cutting or punching different motives into the provided multilayer structure.

FIG. 9 shows on the right side again the SEM picture of a cross-section through the first embodiment of the thin film device 1. Further, FIG. 9 shows for comparison on the left side a SEM picture of another thin film layer device which was manufactured by a method different to the method described above.

The device on the left side, which is no part of an embodiment, comprises a stainless steel substrate 8 on which an unwanted mixed metal oxide layer 9 is formed. No smooth surfaces between the single layers are provided. An intermediate layer 10 between the metal oxide layer and a ceramic thin film layer 11 consists of lanthanum nickelate (lanthanum nickel oxide, LNO). The ceramic thin film layer comprises a barium zirconium titanate ceramic and unwanted metal impurities caused by interdiffusion between the metal and metal oxide layers and the ceramic thin film.

The impurities have a significant unwanted impact to the mechanical and particularly to the electrical properties of the ceramic thin film 5.

In table 2 the results of an EDX measurement of the composition of the base layer, the intermediate layer and the ceramic thin film of the non-inventive device are shown. The before described impurities because of interdiffusion effects can be recognized. The ratios of the different elements are stated in atom %.

TABLE 2

| | O | Si | Ti | Cr | Fe | Ni | Zr | Ba | La |
|---|---|---|---|---|---|---|---|---|---|
| Ceramic | 64.7 | — | 11.8 | — | 1.12 | — | 1.9 | 19.3 | 1.1 |
| thin film | | | | | | | | | |
| Inter- | 49.3 | 0.3 | 1.4 | 2.4 | 3.8 | 21.4 | 0.4 | 2.6 | 18.3 |
| mediate | | | | | | | | | |
| layer | | | | | | | | | |
| Metal | 41.9 | 1.6 | — | 27.4 | 14.1 | 4.6 | — | — | 6.4 |
| oxide | | | | | | | | | |
| layer | | | | | | | | | |
| Base layer | — | 1.6 | — | 17.1 | 73.8 | 6.1 | — | — | — |

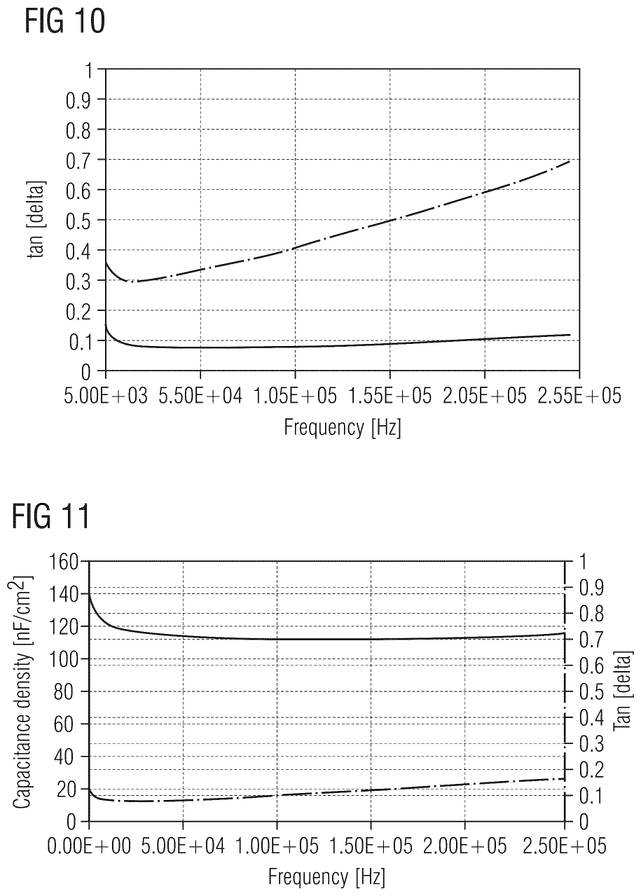

FIG. 10 shows the losses in electrical power at different applied electrical frequencies in comparison between the first embodiment of the inventive device 1 (solid line) and the non-inventive embodiment of a thin film device (dashed line).

The electrical losses are stated as tan (delta). The frequency is given in Hertz (Hz). The measurements were conducted at room temperature.

It can be clearly seen in FIG. 10 that for the inventive embodiment the electric losses are smaller and less dependent of the frequency. In particular, with an increasing frequency the losses can be reduced significantly.

FIG. 11 shows the capacitance density in nF/cm² (solid line) and again the electrical losses (dashed line) for the same inventive embodiment of the thin film device 1. As can be seen from FIG. 11, capacitance density and electrical losses are not or only little dependent on the applied electrical frequency.

The measurements were again conducted at room temperature.

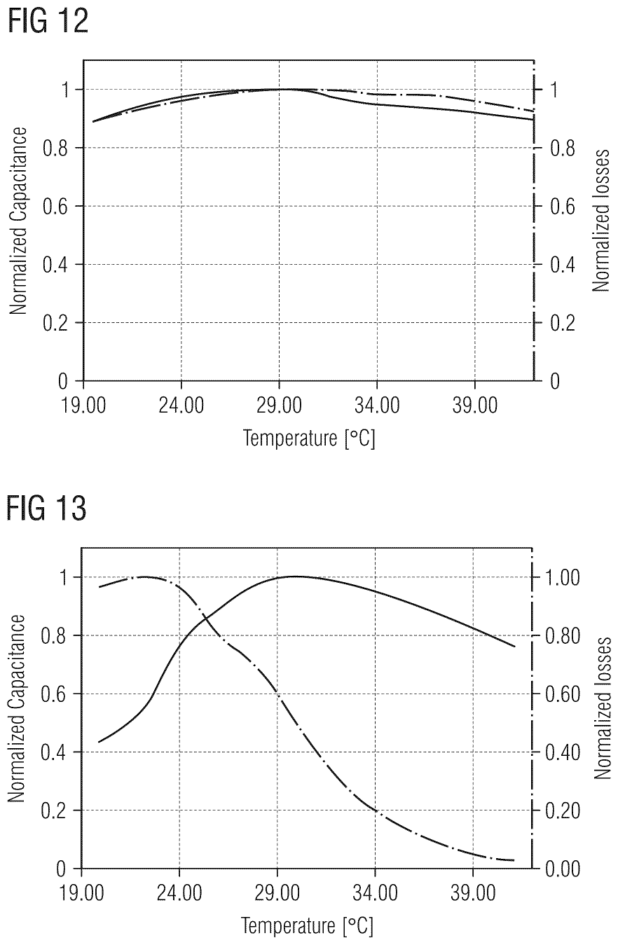

FIG. 12 shows the dependency of the electrical capacitance and the electrical losses on the temperature for the inventive first embodiment of the thin film device 1. In a temperature range between 19.5 °C and 42 °C both values experience a variation of less than 10%. Thus, the thin film device 1 is suitable for applications at body temperature, e.g. at the human body.

In particular, the thin film device 1 may be used as a dielectrical electrode structure for the application of an electrical field to the human body for cancer treatment by tumor treating electrical fields.

FIG. 13 shows for comparison the dependency of the electrical capacitance and the electrical losses on the temperature for the non-inventive embodiment of the device. In a temperature range between 19.5 °C and 42 °C both values experience a huge variation.

As a result, the inventive device 1 exhibits a lower temperature dependency of the electrical capacitance and the electrical losses.

Furthermore, the thin film device has a favorable high dielectric breakdown strength.

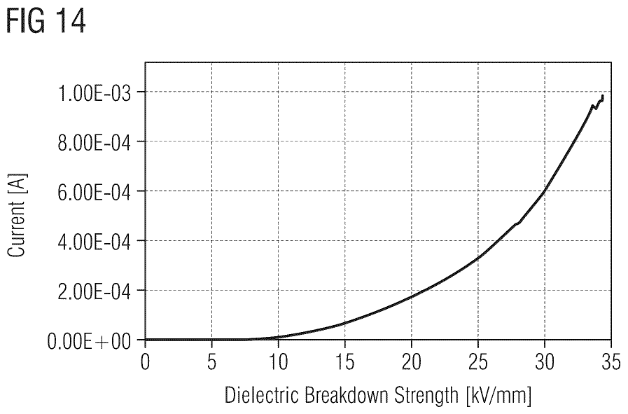

FIG. 14 shows the dielectric breakdown strength of the first embodiment of the thin film device. The dependency of electric current on the electric filed is measured. The breakdown point is about 33 kV/mm.

1.-38. (canceled)

39. A substrate comprising:
a base layer comprising titanium; and
an intermediate layer comprising titanium oxide.

40. The substrate according to claim 39, wherein the substrate is adapted so that a thin film ceramic layer is depositable on the intermediate layer.

41. The substrate according to claim 39, wherein the intermediate layer and the base layer are direct adjacent layers.

42. The substrate according to claim 39, wherein the substrate consists of the base layer and the intermediate layer.

43. The substrate according to claim 39, wherein the base layer has a thickness between 5 μm and 1000 μm, inclusive.

44. The substrate according to claim 39, wherein the base layer has a surface roughness Ra of less than 0.3 μm.

45. The substrate according to claim 39, wherein the intermediate layer has a thickness between 0.1 μm and 2 μm, inclusive.

46. The substrate according to claim 39, wherein the base layer consists of titanium and the intermediate layer consists of titanium oxide.

47. The substrate according to claim 39, wherein a thickness of the intermediate layer is larger than a thickness of a natural oxidation layer on the titanium.

48. The substrate according to claim 47, wherein the intermediate layer has a suitable structure and a minimum layer thickness to exhibit self-healing oxidation properties.

49. The substrate according to claim 39, wherein the intermediate layer exhibits self-healing properties.

50. The substrate according to claim 39, wherein the intermediate layer has no open porosity.

51. A thin film device comprising:
the substrate according to claim 39; and
a thin film ceramic layer arranged on the intermediate layer.

52. The thin film device according to claim 51, wherein the intermediate layer and the thin film ceramic layer are direct adjacent layers.

53. The thin film device according to claim 51, wherein the thin film device consists of the substrate and the thin film ceramic layer.

54. The thin film device (according to claim 51, wherein the thin film device comprises exactly one inner electrode layer or several inner electrode layers.

55. The thin film device according to claim 54, wherein the thin film device comprises several thin film ceramic layers.

56. The thin film device according to claim 55, wherein each thin film ceramic layer comprises a ceramic material with a composition Ba(ZrₓTi₁₋ₓ)O₃, wherein 0.05≤x≤0.6 is fulfilled, or a ceramic material (PbₓZr₁₋ₓ)TiO₃, wherein 0.4≤x≤0.6 is fulfilled, or a ceramic material Pb(MnₓNb₁₋ₓ)O₃+PbTiO₃, wherein 0.2≤x≤0.4 is fulfilled.

57. The thin film device according to claim 56, wherein the ceramic materials comprises further y weight % of a rare earth metal dopant, and z weight % of a transition metal dopant, and wherein 0.2≤y≤2 and 0.1≤z≤1 are fulfilled.

58. The thin film device according to claim 51, wherein the thin film device is circular plate.

59. The thin film device according to claim 51, wherein the thin film device is a three-dimensionally folded foil.

60. The thin film device according to claim 51, wherein the ceramic thin film layer has a thickness between 0.3 μm and 5 μm, inclusive.

61. A dielectric electrode structure comprising:
the thin film device according to claim 51.

62. A capacitor structure comprising:
the thin film device according to claim 51.

63. A multilayer ceramic capacitor structure comprising:
the thin film device according to claim 51.

64. A medical device comprising:
the thin film device according to claim 51.

65. A method for manufacturing a substrate, the method comprising:
providing a titanium foil to form a base layer; and
thermally or anodically treating the base layer to form an intermediate layer directly adjacent to the base layer comprising titanium oxide.

66. The method according to claim 65, wherein, while thermally treating, the base layer is heated up to a first holding temperature in a first step and to a second holding temperature higher than the first holding temperature in a second step.

67. The method according to claim 66, wherein the first holding temperature is between 550 °C and 620 °C, inclusive and the second holding temperature is between 640 °C and 700 °C, inclusive.

68. The method according to claim 65, wherein the intermediate layer is self-healed by applying an electrical field to the substrate inducing formation of new titanium oxide.

69. A method for manufacturing a thin film device, the method comprising:
providing a ceramic material for a ceramic thin film layer in a viscous state;
depositing the ceramic material in the viscous state on a surface of an intermediate layer facing away from a base layer to form a thin film ceramic layer;
drying the deposited thin film ceramic layer;
calcination of the dried thin film ceramic layer; and
crystallizing the calcined thin film ceramic layer.

70. The method according to claim 69, wherein providing the ceramic material in the viscous state comprises:
dissolving a barium salt in a first solution;
dissolving an organic polymer in a second solution;
dissolving titanium tetraethoxide and zirconium propoxide in the second solution; and
mixing the first and the second solution to form a sol gel.

71. The method according to claim 70, wherein the organic polymer of the second solution is polyvinylpyrrolidone.

72. The method according to claim 69, wherein z deposition of the ceramic material is done by slot die coating.

73. The method according to claim 72, wherein the ceramic material is deposited by stacking several sublayers, and wherein each sublayer has a thickness between 0.1 μm and 0.5 μm, inclusive.

74. The method according to claim 69, wherein drying the ceramic thin film layer is conducted at a temperature between 150 °C and 250 °C, wherein calcinating the thin film layer is conducted in two steps at temperatures between 300 °C and 600 °C and wherein crystallizing of the thin film layer is conducted at a temperature between 600 °C and 700 °C.

75. The method according to claim 69, wherein a geometrical shape of the thin film device is configured by cutting or punching.

76. The method according to claim 69, wherein the thin film device is three-dimensionally shaped by cutting and folding.
